(19) United States
(12) Patent Application Publication
(10) Pub. No.: US 2023/0258920 A1
(43) Pub. Date: Aug. 17, 2023

(54) Beam Splitter Assembly, Method for the Dimensioning Thereof and Microscope

(71) Applicant: Carl Zeiss Microscopy GmbH, Jena (DE)

(72) Inventors: Thomas Nobis, Leipzig (DE); Wolfgang Bathe, Jena (DE)

(21) Appl. No.: 18/109,304

(22) Filed: Feb. 14, 2023

(30) Foreign Application Priority Data
Feb. 15, 2022 (DE) 10 2022 103 459.3

(51) Int. Cl. G02B 21/36; G02B 27/10; G02B 27/28

(52) U.S. Cl. CPC G02B 21/361; G02B 27/1013; G02B 27/1066; G02B 27/283

(57) ABSTRACT

Disclosed is a beam splitter assembly for being arranged in a non-collimated part of a beam path of a microscope with a first plate, which is tilted with respect to an optical axis by a tilting angle, and with a second plate, which is tilted with respect to the optical axis by a tilting angle, wherein the first plate and/or the second plate serve(s) for coupling radiation in and/or out. The beam splitter assembly can include a wedge angle of the first plate, a wedge angle of the second plate and the tilting angle of the second plate, which are coordinated with one another in such a way that an astigmatism on the optical axis and a linear field dependence of the astigmatism in an object field are corrected. Also disclosed are a method for dimensioning a beam splitter assembly and a microscope.

### REFERENCE TO RELATED APPLICATIONS

The current application claims the benefit of German Patent Application No. 10 2022 103 459.3, filed on 15 Feb. 2023, which is hereby incorporated by reference.

### FIELD OF THE DISCLOSURE

The invention relates in a first aspect to a beam splitter assembly for being arranged in a non-collimated part of a beam path of a microscope according to the preamble of claim 1. The invention also relates to a method for dimensioning the beam splitter assembly and also to a microscope.

### BACKGROUND OF THE DISCLOSURE

A beam splitter assembly of the type in question for being arranged in a non-collimated part of a beam path of a microscope has a first plate, which is tilted with respect to an optical axis by a tilting angle. There is also a second plate, which is tilted with respect to the optical axis by a tilting angle. In this case, the first plate and/or the second plate serve(s) for coupling radiation in and/or out or are designed for these purposes.

Beam splitter assemblies of the type in question are known from DE 10 2009 044 987 A1 and DE 10 2004 058 833 A1.

In reflected-light microscopy, particularly in reflected-light fluorescence microscopy, it is important for the illumination light or excitation light to be separated from the light of the radiation to be detected. This separation generally takes place by means of plane-parallel splitter plates with a suitable coating, which act as deflection mirrors at (usually) 45° to the optical axis. Such plates are suitably introduced into the imaging beam path at a position at which the detection light is collimated, that is to say the image captured by the microscope is at infinity. At such a point, the plane-parallel splitter plates do not cause any imaging aberrations for the image quality, or at least they are negligible for the system as a whole.

The accessible region of the beam path in which the detection light is collimated is also referred to as the infinity space. However, the infinity space is limited and, for typical microscope stands available, is already occupied by a series of splitter plates. Furthermore, the entire geometric arrangement of the connected subsystems on the microscope stand can prevent a further interface in the infinity space. Therefore, beam splitting and/or beam combining outside the infinity space, that is to say in the convergent beam path, is also desirable. At such a point, however, a plane-parallel plate already causes clear imaging aberrations that are not at all tolerable for the system as a whole, specifically astigmatism, lateral chromatic aberration and coma, in each case on the optical axis. An arrangement according to the prior art, in which all of these aberrations are compensated, consists of altogether four plane-parallel plates, which are arranged inclined by 45° to the optical axis, and are additionally turned azimuthally in relation to one another by 90° in each case about the optical axis. Apart from the altogether four components required for this, such an arrangement is long, and the back focal lengths of the optical unit concerned are generally too short, in order to accommodate the entire structure within the other geometric requirements of a microscope stand.

### SUMMARY OF THE DISCLOSURE

It can be considered an object of the invention to provide a beam splitter assembly of the aforementioned type which has improved properties with regard to use in a microscope, in particular a wide-field microscope. It is also intended to provide a method for dimensioning such a beam splitter assembly and a microscope.

This object is achieved by the beam splitter assembly with the features of claim 1, the method with the features of claim 16 and the microscope with the features of claim 19.

According to the invention, the beam splitter assembly of the type specified above is developed by providing that a wedge angle of the first plate, a wedge angle of the second plate and the tilting angle of the second plate are coordinated with one another in such a way that an astigmatism on the optical axis and a linear field dependence of the astigmatism in an object field are corrected.

The microscope according to the invention has an illumination beam path and a detection beam path and there is at least one beam splitter assembly according to the invention in the illumination beam path and/or in the detection beam path.

In the method according to the invention for dimensioning a beam splitter assembly according to the invention, for a given distance of the first plate from the second plate on the optical axis and a given tilting angle of the first plate relative to the optical axis, the wedge angle of the first plate, the wedge angle of the second plate and a tilting angle of the second plate are varied until the astigmatism on the optical axis and a linear field dependence of the astigmatism in an object field are corrected.

Advantageous configurations of the beam splitter assembly according to the invention and of the microscope according to the invention and advantageous variants of the method according to the invention are described below, in particular with reference to the dependent claims and the figures.

The term plate refers to an at least partially transparent plate. The plate may in particular have the form of a wedge, in the sense that its thickness decreases linearly in one direction. The wedge angles are generally small, in particular not greater than a few degrees. The plates do not have to be wedges in the sense that they have a sharp edge. Strictly speaking, they are then only partial wedges. The plates are therefore basically flat cuboids in which the opposite surfaces deviate slightly from parallelism, specifically are tilted with respect to one another by the wedge angle. The plates may therefore also be referred to as wedge plates or else simply as wedges. The cross section of a wedge is generally independent of the location of the vertical coordinate, for example the y coordinate, where the cross section is taken. For the purposes of the present description, the tilting angle of a plate with respect to the optical axis is intended to be the angle by which that side surface of the plate which is the entry surface for radiation to be coupled in or out is tilted with respect to a normal to the optical axis. Other definitions are possible, for example the tilting angle may also be measured with respect to the angle bisector of the cross-sectional area.

The illumination beam path of the microscope comprises all of the optical components, in particular lenses, objectives, mirrors, prisms, stops, beam splitters and filters, that serve for directing the illumination light or excitation light onto or into a specimen.

The detection beam path of the microscope comprises at least one microscope objective and in addition all further optical components, in particular lenses, objectives, mirrors, prisms, stops, beam splitters and filters, that serve for directing the detection light emitted by the specimen as a result of being irradiated with the illumination light or excitation light onto a camera or some other detector or an eyepiece. The detection light may be in particular fluorescent light, which has a greater wavelength in comparison with the excitation light.

The invention has realized that it is sufficient for achieving correction results that are acceptable and sufficient for most applications to use only two plates. In particular in comparison with assemblies with four plates, advantages with regard to overall size and costs can therefore be achieved by the invention.

The invention has also realized that it is also possible with two plates to achieve a correction of the linear field dependence of the astigmatism in an object field.

The variations of the geometric parameters of the first plate and the second plate may preferably be carried out with suitable software on the computer. The optimization may be carried out for example by using the Levenberg-Marquardt algorithm (LMA or LM), also known by the term DLS method (damped least-squares method). These methods are available in commercially available optics programs.

In an advantageous variant of the method according to the invention, the wedge angle of the first plate, the wedge angle of the second plate and a tilting angle of the second plate are varied until the lateral chromatic aberration on the optical axis is also corrected.

Correspondingly, in a preferred configuration of the beam splitter assembly according to the invention, the wedge angle of the first plate, the wedge angle of the second plate and the tilting angle of the second plate may be coordinated with one another in such a way that a lateral chromatic aberration on the optical axis is also corrected.

In an advantageous variant of the method according to the invention, a position of the second plate on the optical axis is varied in order to minimize coma and/or the lateral chromatic aberration over the object field.

Correspondingly, in a preferred configuration of the beam splitter assembly according to the invention, the position of the second plate on the optical axis may be chosen such that coma and/or the lateral chromatic aberration over the object field is/are minimized.

The second plate is expediently tilted relative to the optical axis in the opposite direction to the first plate.

In the microscope according to the invention, the first plate of the beam splitter assembly preferably serves for coupling radiation into the beam path of the microscope and/or for coupling radiation out of the beam path of the microscope. It is however also possible that, as an alternative or in addition, the second plate is used for these purposes.

In the microscope according to the invention, the first plate of the beam splitter assembly is generally arranged upstream of the second plate in the detection beam path. This is not mandatory, however. The opposite arrangement is also possible, that is to say an arrangement in which the detection light passes first through the second plate and then through the first plate.

In principle, the beam splitter assembly according to the invention can be used in a microscope in non-collimated, for example in convergent, parts of the illumination beam path and/or the detection beam path. In an advantageous variant of the microscope according to the invention, a beam splitter assembly according to the invention is arranged between a tube lens and the associated intermediate image plane.

In principle, the distances of the first plate and/or the second plate from an intermediate image plane can be chosen largely freely in each case. In an advantageous configuration of the microscope according to the invention, the first plate and/or the second plate of the beam splitter assembly is/are at a distance from an intermediate image plane of between 30 mm and 200 mm.

The beam splitter assembly according to the invention is suitable in particular for specific ranges of values of the angle convergence of the beam path between the tube lens and the intermediate image. In an advantageous variant of the microscope according to the invention, the following applies for the numerical aperture NA in the intermediate image: NA≤0.1 and in particular 0.002≤NA≤0.05.

In a further advantageous variant of the microscope according to the invention, an image diameter of the intermediate image downstream from a tube lens may be a few millimetres, for example 2 millimetres, to 40 millimetres.

In principle, the material of the plates only has to meet a requirement to the extent that it is sufficiently transparent to the radiation that is used and that the time-of-flight differences necessary for the corrections to be accomplished can be provided. To this end, it is not absolutely necessary in principle that the plates consist of a homogeneous material. But if the latter is the case, it is easier to find the suitable plate or wedge geometries and arrangements. Preferred embodiments of the beam splitter assembly according to the invention are therefore distinguished by the fact that the first plate and/or the second plate consist(s) in volume of a homogeneous material with a single refraction index or each consist of a homogeneous material with a single refraction index.

Because the corrections to be accomplished for the invention are achieved by way of time-of-flight differences for the respective beam paths through the plates used, the specific physical beam-splitting mechanism as such does not play a significant role for the effect of the invention. Accordingly, the coupling in or out of radiation may take place by various physical mechanisms that are known in principle.

For example, the plate in the beam splitter assembly may be neutral beam splitters, for example 50:50 neutral beam splitters, chromatic beam splitters and/or polarization beam splitters. In principle, mixed forms or combinations of beam splitters based on different mechanisms of action are also possible in one and the same beam splitter assembly.

Because the compensation for the astigmatism described above is dependent on the refractive index, it strictly only applies for a chosen reference wavelength, for example a wavelength in the green spectral range (546 nm). Therefore, a small residual contribution to the astigmatism generally remains for other colours, but can be tolerated for microscopy. Improvements in the correction also for different wavelengths can be achieved in the case of the beam splitter assembly according to the invention if the first plate and/or the second plate is/are a chromatically corrected double wedge or they are in each case chromatically corrected double wedges. Multiple wedges consisting of more than two wedges are also possible. Such components are comparatively expensive.

With regard to the tilting angle of the first plate relative to the optical axis, there is in principle a freedom of design. Therefore, radiation does not necessarily have to be coupled in or out perpendicularly to the optical axis. In advantageous variants of the beam splitter assembly according to the invention, the first plate is tilted relative to the optical axis by an angle in the range between 30° and 70°, preferably in the range between 40° and 50° and in particular by 45°.

A wedge angle of the first plate may be in the range between 0 arc minutes and 30 arc minutes and preferably between 3 arc minutes and 10 arc minutes.

The second plate may be tilted relative to the optical axis by an angle in the range between 20° and 60° and preferably in a range between 30° and 40°. A wedge angle of the second plate may be in the range between 0 arc minutes and 60 arc minutes and preferably between 8 arc minutes and 25 arc minutes.

A plate with a wedge angle of 0 is a plane-parallel plate.

The first plate and/or the second plate may have a plate thickness of between 0.5 mm and 20 mm.

### BRIEF DESCRIPTION OF THE DRAWINGS

Further advantages and properties of the present invention are explained below with reference to the attached figures, in which:

FIG. 1 shows a schematic view of a beam splitter assembly according to the invention, and

FIG. 2 shows a further schematic view of the beam splitter assembly from FIG. 1 to explain the geometric parameters relevant to the dimensioning.

### DETAILED DESCRIPTION

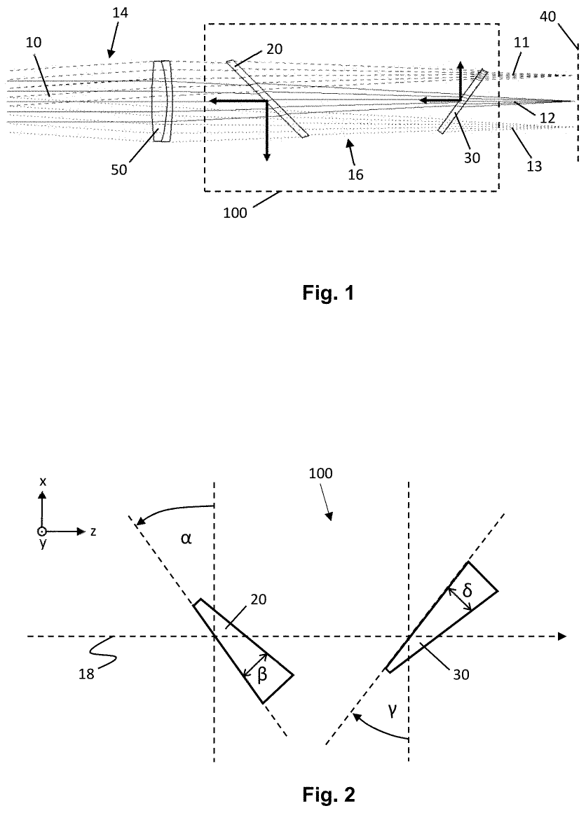

The exemplary embodiment of a beam splitter assembly 100 according to the invention that is schematically shown in FIG. 1 has a first plate 20 and a second plate 30. The relevant geometric variables are illustrated in FIG. 2.

The first plate is tilted with respect to an optical axis 18 by a tilting angle α. The second plate 30 is tilted with respect to the optical axis 18 by a tilting angle γ. The second plate 30 is tilted relative to the optical axis 18 in the opposite direction to the first plate 20.

As can be seen from FIG. 2, the tilting angle α of the first plate 20 and the tilting angle γ of the second plate 30 are in each case measured from the side surface of the respective plate that is towards a normal to the optical axis 18. Other definitions are possible, for example the tilting angles may also be measured with respect to the angle bisectors of the respective cross-sectional areas of the plates.

The first plate 20 may be tilted relative to the optical axis 18 by an angle of 45°. This is not mandatory, however. For example, the first plate 20 may be tilted relative to the optical axis 18 by an angle α in the range between 30° and 70° and preferably by an angle α in the range between 40° and 50°. The second plate 30 may be tilted relative to the optical axis 18 by an angle γ in the range between 20° and 60° and preferably in a range between 30° and 40°.

The first plate 20 and/or the second plate 30 may have a plate thickness of between 0.5 mm and 20 mm.

The first plate 20 has a wedge angle β and the second plate 30 has a wedge angle θ. The wedge angle β of the first plate 20 may be for example in the range between 0 arc minutes and 30 arc minutes and preferably between 3 arc minutes and 10 arc minutes. The wedge angle δ of the second plate 30 may be for example in the range between 0 arc minutes and 60 arc minutes and preferably between 8 arc minutes and 25 arc minutes.

In the exemplary embodiment shown in FIG. 1, the beam splitter assembly 100 according to the invention is arranged in a beam path 10 of a microscope that is not shown in detail. In FIGS. 1 and 2, the detection beam path of the microscope runs from left to right, i.e. in FIG. 2 in the z direction. If for example excitation light is coupled in by way of the first plate 20, the illumination beam path runs from the first plate 20 to the left. The reference sign 14 denotes a collimated part of the beam path 10, known as the infinity space. Further to the left in the beam path in FIG. 1 there is a microscope objective (not shown) and a specimen to be examined. The beam splitter assembly 100 is arranged in a convergent part 16 of the beam path 10 between a tube lens 50 and an intermediate image plane 40.

In FIG. 1, the beam path is schematically shown with three separate beams 11, 12, 13 of the detection beam path, which in each case emanate from different points in a specimen plane that is not shown. The first plate 20 and/or the second plate 30 of the beam splitter assembly 100 may be for example at a distance from the intermediate image plane 40 of between 30 mm and 200 mm. The numerical aperture NA in the intermediate image may be for example less than or equal to 0.1 and in particular may be 0.002≤NA≤0.05. An image diameter of the intermediate image in the intermediate image plane 40 may be for example in the range of a few millimetres, for example 2 millimetres, to 40 millimetres.

The first plate 20 and, as an alternative or in addition, the second plate 30 of the beam splitter assembly 100 may serve for coupling radiation in and/or out.

For example, excitation light, for instance for exciting fluorescence, may be coupled into the beam path and detection light, typically red-shifted fluorescent light of dyes with which a specimen has been prepared, may be coupled out of the beam path. The arrows shown in FIG. 1 and lying on the optical axis 18 at the first plate 20 and at the second plate 30 respectively show the direction of radiation coupled into the beam path 10. The arrows shown in FIG. 1 and lying transversely to the optical axis at the first plate 20 and at the second plate 30 respectively show the direction of radiation coupled out of the beam path 10.

For this purpose, the first plate 20 and/or the second plate 30 may be formed as neutral-beam splitters, for example 50:50 neutral-beam splitters, as chromatic beam splitters and/or as polarization beam splitters.

In the exemplary embodiment shown in FIGS. 1 and 2, the first plate 20 of the beam splitter assembly 100 is arranged upstream of the second plate 30 in the detection beam path, i.e. the detection light passes first through the first plate 20 and then through the second plate 30. This is not mandatory, however; the opposite arrangement is also possible.

The essential problem addressed by the invention of coupling radiation into the convergent part of the beam path of a microscope or coupling radiation out of the convergent part of this beam path is solved according to the invention by the first plate 20 and the second plate 30, which are specifically dimensioned for this purpose and are arranged in a specific way relative to one another and relative to the optical axis 18.

The first plate 20 is generally, but not necessarily, oriented by 45° relative to the optical axis 18 of the beam path, in order to obtain the beam combining in the sense of a deflection mirror. An axial position of the first plate 20 in the beam path 10 is generally predetermined by external conditions of the application or the construction.

The degrees of freedom thus remain for the optimization:

(i) wedge angle β of the first plate 20

(ii) tilting angle γ of the second plate 30

(iii) wedge angle δ of the second plate 30

(iv) distance of the second plate 30 from the intermediate image plane 40

(v) possibly: thicknesses of the two plates

It is generally endeavored to optimize these degrees of freedom given above in such a way that the aberrations produced by the first plate 20 together with the second plate 30 over the image field used are minimized and residual aberrations are reduced to a tolerable amount.

The principle of the compensation according to the invention is based on the following approach:

An astigmatism which a plane-parallel plate at any desired angle on the optical axis 18 produces may be exactly compensated by a defined wedge angle of this plate, that is to say the first plate 20, on the optical axis 18.

Remaining as a dominant residual aberration is a lateral chromatic aberration on the optical axis 18, which is caused both by the finite thickness of the inclined first plate 20 (wavelength-dependent beam offset) and by its wedge shape (prism effect). The astigmatism then also has a field-linear profile away from the optical axis 18.

The second plate 30 serves for compensating for these remaining aberrations. If the second plate 30 is tilted by the same tilting angle as the first plate 20, irrespective of the sign, the second plate 30 produces an additional contribution to the astigmatism. This can always be compensated by a suitably changed wedge angle β of the first plate 20 and/or by a suitably changed wedge angle δ of the second plate 30.

If the second plate 30 is tilted by the same tilting angle, but in the opposite direction, with respect to the optical axis 18 to the first plate 20, if therefore the sign of the inclination is changed, this arrangement tends to have a compensating effect for the remaining lateral chromatic aberration. Therefore, for a fixed axial position chosen for the second plate 30 and for a fixed tilting angle chosen for the second plate 30, there exists a combination of the wedge angle β of the first plate 20 and the wedge angle δ of the second plate 30 for which the astigmatism on the optical axis 18 disappears.

It is also found that there is the tendency that, in the final solution, the first plate 20 and the second plate 30 each only in themselves produce minor contributions to the astigmatism, i.e. they are in themselves already almost corrected.

Because such a solution exists for each tilting angle γ of the second plate 30, this remaining degree of freedom is used according to the invention to also correct the linear field dependence of the astigmatism.

In the beam splitter assembly 100 according to the invention, therefore, with a given tilting angle α of the first plate 20 with respect to the optical axis 18, the wedge angle β of the first plate 20, the wedge angle δ of the second plate 30 and the tilting angle γ of the second plate 30 are coordinated with one another in such a way that an astigmatism on the optical axis 18 and a linear field dependence of the astigmatism in an object field are corrected.

In the method according to the invention for dimensioning a beam splitter assembly according to the invention, therefore, with a given distance of the first plate 20 from the second plate 30 on the optical axis 18 and a given tilting angle α of the first plate 20 relative to the optical axis 18, the wedge angle β of the first plate 20, the wedge angle δ of the second plate 30 and a tilting angle γ of the second plate 30 are varied until the astigmatism on the optical axis 18 and a linear field dependence of the astigmatism in an object field are corrected.

For a fixed position chosen for the second plate on the optical axis 18 and for a fixed tilting angle γ chosen for the second plate 30, there exists a combination of a wedge angle β of the first plate 20, a wedge angle δ of the second plate 30 for which both the astigmatism and the lateral chromatic aberration on the optical axis 18 disappear, are therefore corrected.

In a corresponding variant of the method according to the invention, the wedge angle β of the first plate 20, the wedge angle δ of the second plate 30 and a tilting angle γ of the second plate 30 are varied until the lateral chromatic aberration on the optical axis 18 is corrected.

The coma contributions of the first plate 20 and the second plate 30 are minor for the numerical apertures in the intermediate image plane 40 occurring in microscopy and can be accepted in practice. If appropriate, the axial position of the second plate can be optimized in such a way that the influence of the coma and also a field profile of the lateral chromatic aberration are also minimal.

In the corresponding variant of the method according to the invention, a position of the second plate 30 on the optical axis 18 is varied in order to minimize coma and/or the lateral chromatic aberration over the object field.

The first plate 20 and the second plate 30 do not have to be of the same thickness. However, variations in the thicknesses of the plates do not provide any further significant improvements in the procedure described above.

Furthermore, because of the asymmetry in the x and y directions, the plates cause a slight change in scale between the x and y axes, which however plays no role, in particular for scanning systems in microscopy, and can be compensated by calibrating the scanner axes.

The compensation for the astigmatism explained above is dependent on the refractive index and therefore, at least if the first plate 20 and the second plate 30 each consist in volume of a homogeneous material with a single refraction index or a single refractive index, strictly only applies in general for a chosen reference wavelength, for example a wavelength in the green spectral range (546 nm). Therefore, a small residual contribution to the astigmatism generally remains for other colours, but can be accepted for microscopy.

If these residual amounts are also to be compensated or reduced, chromatically corrected double wedges or multiple wedges may be used for the first plate 20 and/or the second plate 30.

The present invention provides a novel beam splitter assembly for use in the convergent beam path of microscopes which requires only a few components, is consequently space-saving, and with which sufficient compensations of beam aberrations can be achieved for the purposes of microscopy for most applications.

### LIST OF REFERENCE SIGNS

10 Beam path of a microscope
11 Partial beam of the beam path 10
12 Partial beam of the beam path 10
13 Partial beam of the beam path 10
14 Collimated part of the beam path 10, infinity space
16 Convergent part of the beam path 10
18 Optical axis
20 First plate
30 Second plate
40 Intermediate image plane
50 Tube lens
100 Beam splitter assembly according to the invention
α Tilting angle of the first plate 20 relative to the normal to the optical axis 18
β Wedge angle of the first plate 20
γ Tilting angle of the second plate 30 relative to the normal to the optical axis 18
δ Wedge angle of the second plate 30

What is claimed is:

1. Beam splitter assembly for being arranged in a non-collimated part of a beam path of a microscope, the assembly comprising:
a first plate, which is tilted with respect to an optical axis by a tilting angle, and
a second plate, which is tilted with respect to the optical axis by a tilting angle,
wherein the first plate and/or the second plate serve(s) for coupling radiation in and/or out,
wherein a wedge angle of the first plate, a wedge angle of the second plate and the tilting angle of the second plate are coordinated with one another in such a way that an astigmatism on the optical axis and a linear field dependence of the astigmatism in an object field are corrected.

2. Beam splitter assembly according to claim 1,
wherein the wedge angle of the first plate, the wedge angle of the second plate and the tilting angle of the second plate are coordinated with one another in such a way that a lateral chromatic aberration on the optical axis is also corrected.

3. Beam splitter assembly according to claim 1,
wherein the position of the second plate on the optical axis is chosen such that coma and/or the lateral chromatic aberration over the object field is/are minimized.

4. Beam splitter assembly according to claim 1,
wherein the first plate and/or the second plate consist(s) in volume of a homogeneous material with a single refraction index or each consists of a homogeneous material with a single refraction index.

5. Beam splitter assembly according to claim 1,
wherein the first plate and/or the second plate is/are a neutral-beam splitter or are in each case neutral-beam splitters.

6. Beam splitter assembly according to claim 1,
wherein the first plate and/or the second plate is/are a 50:50 neutral-beam splitter or are in each case 50:50 neutral-beam splitters.

7. Beam splitter assembly according to claim 1,
wherein the first plate and/or the second plate is/are a chromatic beam splitter or are in each case chromatic beam splitters.

8. Beam splitter assembly according to claim 1,
wherein the first plate and/or the second plate is/are a polarization beam splitter or are in each case polarization beam splitters.

9. Beam splitter assembly according to claim 1,
wherein the first plate and/or the second plate is/are a chromatically corrected double wedge or are in each case chromatically corrected double wedges.

10. Beam splitter assembly according to claim 1,
wherein the first plate is tilted relative to the optical axis by an angle in the range between 30° and 70°.

11. Beam splitter assembly according to claim 1,
wherein a wedge angle of the first plate is in the range between 0 arc minutes and 30 arc minutes.

12. Beam splitter assembly according to claim 1,
wherein the second plate is tilted relative to the optical axis in the opposite direction to the first plate.

13. Beam splitter assembly according to claim 1,
wherein the second plate is tilted relative to the optical axis by an angle in the range between 20° and 60°.

14. Beam splitter assembly according to claim 1,
wherein a wedge angle of the second plate is in the range between 0 arc minutes and 60 arc minutes.

15. Beam splitter assembly according to claim 1,
wherein the first plate and/or the second plate has or have a plate thickness of between 0.5 mm and 20 mm.

16. Method for dimensioning a beam splitter assembly according to claim 1,
in which, for a given distance of the first plate from the second plate on the optical axis and a given tilting angle of the first plate relative to the optical axis, the wedge angle of the first plate, the wedge angle of the second plate and the tilting angle of the second plate are varied until the astigmatism on the optical axis and a linear field dependence of the astigmatism in an object field are corrected.

17. Method according to claim 16,
wherein the wedge angle of the first plate, the wedge angle of the second plate and a tilting angle of the second plate are varied until the lateral chromatic aberration on the optical axis is corrected.

18. Method according to claim 16,
wherein a position of the second plate on the optical axis is varied in order to minimize coma and/or the lateral chromatic aberration over the object field.

19. Microscope with an illumination beam path and a detection beam path in which there is at least one beam splitter assembly according to claim 1 in the illumination beam path and/or in the detection beam path.

20. Microscope according to claim 19,
wherein the first plate and/or the second plate of the beam splitter assembly serves or serve for coupling radiation in and/or out.

21. Microscope according to claim 19,
wherein the first plate of the beam splitter assembly is arranged upstream of the second plate in the detection beam path.

22. Microscope according to claim 19,
wherein the beam splitter assembly is arranged between a tube lens and an intermediate image plane.

23. Microscope according to claim 19,
wherein the first plate and/or the second plate of the beam splitter assembly is or are at a distance from an intermediate image plane of between 30 mm and 200 mm.

24. Microscope according to claim 19,
wherein a numerical aperture NA in the intermediate image is less than or equal to 0.1.

25. Microscope according to claim 19,
wherein an image diameter of the intermediate image downstream from a tube lens is 2 millimetres to 40 millimetres.
